(19) United States
(12) Patent Application Publication
(10) Pub. No.: US 2024/0370824 A1
(43) Pub. Date: Nov. 7, 2024

(54) SYSTEM, METHOD, AND COMPUTER READABLE MEDIUM FOR USING BLOCKCHAIN, NFTS, AND SMART CONTRACTS TO TRACK AND REPORT GREENHOUSE GAS EMISSIONS

(71) Applicants: Mark D. Sheldon, University Heights, OH (US); University of Virginia Patent Foundation, Charlottesville, VA (US); Auburn University, Auburn, AL (US)

(72) Inventors: Mark D. Sheldon, University Heights, OH (US); J. Gregory Jenkins, Auburn, AL (US); Eric M. Negangard, Charlottesville, VA (US)

(21) Appl. No.: 18/656,588

(22) Filed: May 6, 2024

Related U.S. Application Data
(60) Provisional application No. 63/464,156, filed on May 4, 2023.

(51) Int. Cl. G06Q 10/10

(52) U.S. Cl. CPC G06Q 10/10

(57) ABSTRACT

Disclosed herein are systems and methods for reliable and verifiable tracking and reporting of value chain data. In one respect, a management system is provided for a value chain platform, configured to: verify digital certificates confirming suppliers' compliance with emissions tracking criteria of the value chain platform; deploy at least one smart contract on a permissioned blockchain of the value chain platform, the smart contract configured to process one or more emissions tokens of upstream suppliers plus emissions data of a current supplier, to automatically mint a new emissions token representing a combination of the two; and generate a report of cumulative emissions for a given product of the value chain, based on the new emissions token.

### CROSS-REFERENCE TO RELATED APPLICATION(S)

This application claims priority to U.S. Provisional Application Ser. No. 63/464,156, filed on May 4, 2023, the entire content of which is incorporated hereby in its entirety.

### STATEMENT OF GOVERNMENT SUPPORT

N/A

### BACKGROUND

Global markets are moving toward requiring firms to track and report greenhouse gas emissions across the value chain. This includes self-generated emissions, emissions from power providers, and emissions from upstream suppliers of goods and services as well as downstream customers (which may be other suppliers in the same value chain) all the way to original equipment manufacturers and/or retailers. However, obtaining reliable, and verifiable, emissions data from all upstream and downstream members of a value chain is a complex and imperfect task that, today, relies on cumbersome legacy processes.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, a management system is provided for a value chain platform comprising a processor; a network interface; a manager interface comprising a display and input device for a manager of the value chain platform; and a memory having stored thereon a set of software instructions which, when executed by the processor, cause the processor to: verify a plurality of digital certificates confirming compliance of a plurality of value chain suppliers of a product value chain, with emissions tracking criteria of the value chain platform; deploy at least one smart contract on a permissioned blockchain of the value chain platform, the smart contract configured to process one or more existing emissions tokens of upstream suppliers and emissions data of a current supplier, to automatically mint a new emissions token representing a combination of the one or more existing emissions tokens and the emissions data of the current supplier; and generate a report of cumulative emissions throughout the product value chain for a given product of the manager, based on the new emissions token from a first tier supplier of the manager.

In another aspect, a method is contemplated for deploying a value chain platform according to the functionality of the foregoing management system.

In another aspect, a method is provided for tracking and reporting a company's emissions information to a value chain platform, comprising: verifying a supplier's admission to the value chain platform; arranging execution of a first smart contract with the supplier, corresponding to a purchase of a supplied good or service from the supplier; receiving and storing data indicative of a first token of the value chain platform, the first token representing aggregated emissions information corresponding to provision of the supplied good or supply service from the supplier to the company; storing company emission data, the company emission data having been generated by tracking emissions caused by the company in generating a sale good or sale service according to requirements of the value chain platform; allocating at least a portion of the aggregated emissions information contained in the first token to generation of the sale good or sale service; and arranging execution of a second smart contract with a customer, corresponding to a sale of the sale good or sale service; wherein execution of the second smart contract combines the company emission data and the portion of the aggregated emissions information contained in the first token to form a second token of the value chain platform representing emissions from the sale of the sale good or sale service.

In another aspect, a system is provided having a processor, memory, and software that causes the performance of the foregoing method within resources of a company.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a block diagram conceptually illustrating an example of a network system in which data regarding goods/services can be exchanged within members of a common value chain.

FIG. 2 is a flow chart describing an example process by which an entity within a value chain can receive, process, and provide data regarding upstream supply and downstream sales of goods/services.

FIG. 3 is a conceptual diagram of a system providing a value chain tracking dashboard according to some embodiments.

FIGS. 4A-4C are example diagrams illustrating tracking indirect emission events throughout a manufacturer's value chain according to some embodiments.

FIG. 5 is an example chart illustrating smart contracts and non-fungible tokens in exchanges between processing, shipping, and manufacturing companies according to some embodiments.

FIG. 6 is an example chart illustrating details of smart contracts used to combine, burn, and mint non-fungible tokens with emissions information according to some embodiments.

FIG. 7 illustrates an example chart illustrating the provenance of emissions throughout a manufacturer's value chain according to some embodiments.

FIG. 8 is a block diagram illustrating an example of a machine according to some embodiments.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts, and embodiments described herein may be implemented and practiced without these specific details. In some instances, well-known structures and components are shown in block diagram form to avoid obscuring such concepts.

As will be described below, the advantages of the present disclosure can be realized in a variety of implementations and from a variety of perspectives. In a broad sense, the present disclosure enables a managed platform through which multiple entities in a value chain can reliably coordinate their tracking of common factors, such as resource usage, climate emissions, social impact, etc.

Thus, embodiments of such a platform may include a system that manages a permissioned, privately-managed or consortium-managed, blockchain network and associated smart contract system, and ensures participants submit their tracking data in a consistent, certified, and auditable manner. Such a system may be ‘permissioned’ in the sense of restricting access to only a certain group of approved participants; in the sense of limiting the permissions of users to view, add, or process data represented in the blockchain network; in the sense of limiting the permissions of users to take certain actions within the blockchain network; and/or in the sense of participants being required to obtain permission from a managing firm/firms before taking certain actions (all as further described below). Similarly, such a system may be deployed by and managed by companies in a variety of ways. For example, a software company may deploy a centralized, cross-compatible value chain platform, that can have multiple ‘channels’ representing different or overlapping value chains. In other words, an embodiment of the invention may be a platform that may have multiple, cross-compatible instances or channels relating to or defined by specific supply chains or value chains. Or, a single instance of a value chain platform may be deployed and managed by a company that controls or participates in that value chain, such as an OEM. In other embodiments, a consortium of companies (e.g., companies within a common industry) may manage such a system, whether it is deployed by a third-party software provider or by one or more of the consortium members. In each alternative implementation, aspects of the network/platform can be configured to allow for retaining confidentiality of participants' confidential business information (e.g., the smart contracts executed within, and tokens represented in, the blockchain network can be anonymous as to any participants except for the two transacting parties, or can be anonymous as to any participants more than a set number of tiers apart, etc.).

In another sense, the present disclosure provides for a company-specific software system/method that allows for interaction with upstream and downstream companies within a value chain, to transfer, process, and generate blockchain tokens indicative of their common factor(s) being tracked. Such a system provides an interface to a smart contract and blockchain ledger, as well as a resource allocation method that is consistently applied to the tracked common factor. In yet another sense, the present disclosure contemplates a software system for a retailer, OEM, or other top-of-value chain company to manage resource usage and other factors throughout a variety of supply tiers. Such a system may take the form of a hosted platform and portal, and/or user dashboard for real-time monitoring and tracking.

In the following discussion, each of these aspects will be described by way of example implementations. However, it is to be understood that description of any given aspect (e.g., platform-wide management system, company-specific software system, top-of-chain dashboard, etc.) may also be describing attributes of, or interactions with, other aspects of the present disclosure as well.

### Example Implementation of Company-Specific Systems and Methods

Description of various embodiments of the present disclosure will begin with the perspective of a given company within a given value chain, and how it interacts with other companies (suppliers, customers, etc.) as well as an overall platform. This perspective will aid understanding of how the overall platform can provide certain advantages and overcome problems with the state of the art.

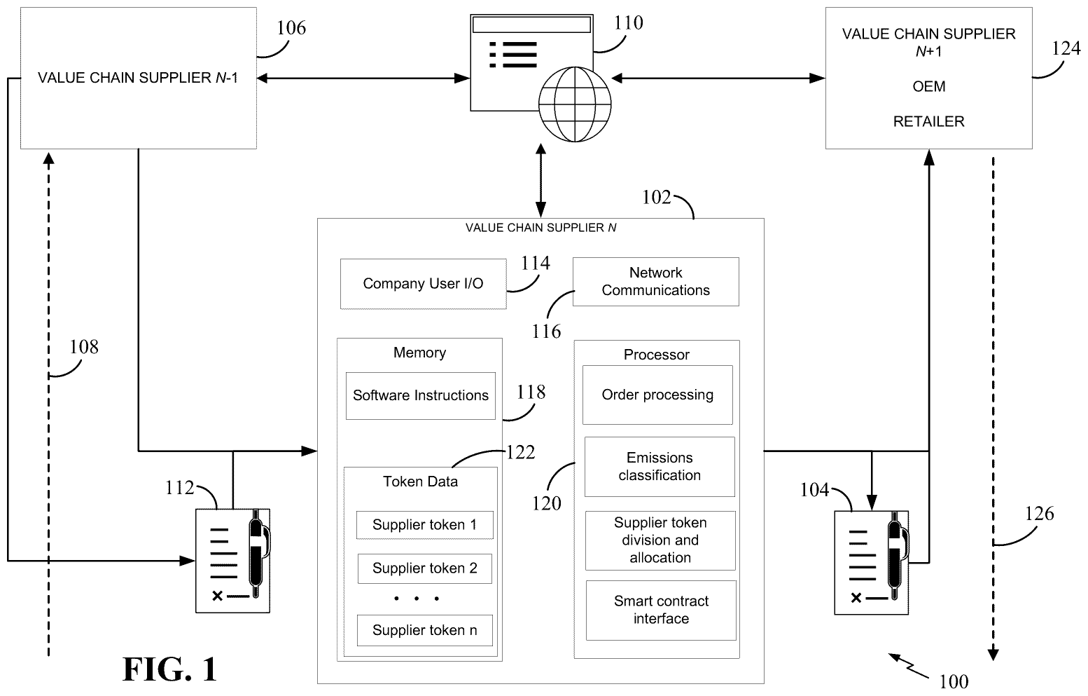

FIG. 1 is a block diagram illustrating dataflow between suppliers of a value chain 100, in accordance with some embodiments. A value chain supplier N 102 can include a company or entity involved in a value chain process. For example, value chain supplier N 102 may be a supplier producing a smart contract 104 for emissions produced across their value chain 100.

As shown in FIG. 1, the example value chain process begins with a value chain supplier N−1 106. The value chain supplier N−1 106 is represented as a supplier of the value chain tier immediately upstream of company N. This upstream supplier N−1 could be any tier of supplier, back to the first company or entity involved in a specific supply process (e.g., manufacturing, producing, resourcing, etc.), or an upstream supplier level dictated by regulatory reporting requirements (e.g., in jurisdictions where emissions tracking requirements extend upstream to a given level or type of supply operation). Thus, the value chain supplier N−1 106 may have received one or more tokens from suppliers that are further upstream within the value chain, including suppliers that are also participants within the same value chain platform or external to the value chain platform of value chain supplier N 102. For example, the resources used by value chain supplier N−1 106 may have been obtained or created by an external supplier who sends a token (e.g., from a side chain or compatible blockchain) to value chain supplier N−1 102 containing emissions data produced from obtaining or creating those resources. In other circumstances, the external supplier may not send a token, and instead may only send general emissions information or no emissions information at all. In such circumstances, the policies and regulations to which value chain supplier N−1 is subject as a condition of participation in the system would dictate how supplier N−1 should estimate emissions associated with the value supplied by such external supplier. In some examples, the value chain supplier N−1 106 can mint a new token usable within the value chain platform that represents such estimated emissions. In some examples, the new token can incorporate and represent data 108 received from the external supplier.

When value chain supplier N 102 purchases products from value chain supplier N−1 106, a smart contract may be executed within blockchain system 110 to represent the emissions allocated to the product sold or services provided from company 106 to company 102. Therefore, blockchain network 110 may include a standard, customizable, or partially customizable smart contract that has been deployed, and by which participants in network 110 can reflect accumulation of emissions (or other resource or factor that is being tracked) at each point of transaction within the value chain. Participants such as company 106 and company 102 may access the smart contract in a variety of ways, such as via a web-based portal that requires secure log-in/identification to ensure the parties that are ‘transacting’ within the blockchain network 110 are properly verified.

Smart contract 112 results in minting of a new token of the blockchain 110. The token will represent an accumulation or aggregation of all emissions attributable to the product/service as of the point it is sold from company 106 to company 102. In this sense, the inputs to smart contract 112 may include various information derived from the terms of sale negotiated between these companies, such as quantity/type of good or service involved, shipment method, and the date or action defining the point at which transfer of title of a good occurs or full performance of a service is completed. In some embodiments, terms of sale between companies may involve an acceptance period. A smart contract 112 associated with such a sale may use the final date of the acceptance period as a date by which the smart contract will ‘execute’ and mint the new emissions token, unless company 102 rejects the goods or services and sends a communication to the platform 110 halting execution of the smart contract. In other embodiments, terms of sale may indicate that title passes upon shipment, in which case company 106 can cause ‘execution’ of the smart contract by certifying shipment has occurred.

Other inputs to the smart contract 112 may include upstream tokens and emissions information for the specific quantity of goods sold or emissions attributable to a service performed (e.g., emissions associated with materials consumed in performance of the service, etc.) and data input to the smart contract 112 by company 102 reflecting that company's tracking of its own emissions. Other information input into the smart contract 112 may include categorization of the emissions, such as which type of Scope 3 emission, or information that would allow for categorization of the emissions by another party. Other information may include the actual form of emission (e.g., whether the emission was CO, NO₂, etc.) and its CO2 equivalent, the method of deriving such equivalence, the way in which the emission was measured (direct measurement, such as by a smart device, or by accepted estimation standard), and the type of activity that generated the emission (e.g., warehousing, transportation, etc.) In some embodiments, smart contract 112 may be the sole contract between companies 106 and 102 for the sale of goods/services between them (and, thus, all terms of the sale will be inputs to the smart contract). In other embodiments, the parties may separately negotiate their transaction, and one or both of them may then be responsible for inputting information relating to their transaction into the deployed smart contract 112 of the networks 110. In some embodiments, the tokens being processed in the smart contract execution may be reflective of specific products, such as components being sold from supplier N−1 to supplier N; in this circumstance, the quantity and nature of the products sold may be inherently input into the smart contract 112.

Once smart contract 112 executes, a new token is generated within the ledger of network 110, that is an aggregation of emissions attributable to the corresponding good or service. From the perspective of network 110, the token is ‘owned’ or ‘attributed’ to company 102 at this time. Thus, in a literal sense, neither company 106 nor company 102 ‘store’ the token. However, in some embodiments, value chain supplier N 102 will store in a local memory 118 certain data corresponding to the newly-generated token resulting from smart contract 112. For example, memory 118 of company 102 may store data representative of the attributes of one or more tokens in a Token Data database 122 (which may be part of the company's enterprise resource system). The representation of the token may be as simple as a pointer to the token as stored in the blockchain 110, or may include information pertaining to the transaction reflected by the token such as total emissions data, the supplier N−1 that was responsible for the token, the order # that precipitated the generation of the token, the specific raw materials, products, or other ‘value’ that is associated with the token within company's operations, etc. In some implementations, the blockchain network 110 may provide an interface or API through which company 102 can access and update information relating to tokens attributed to company 102. (In some implementations, various Hyperledger platforms may refer to such an interface as a world state database).

Thus, value chain supplier N can utilize a device or system 102 operated by the supplier N, to manage interaction with the blockchain network 110, as well as local storage and compilation of information related to emissions data of value chain 100. In some examples, the device can include a company user I/O 114, a network communications module 116, a memory 118, and a processor 120. As illustrated in FIG. 1, processor 120 can be used for various functionalities such as order processing, emissions classification, supplier token aggregation/division/allocation, and interfacing with smart contracts and other aspects of the blockchain network 110, all in accordance with software stored on the memory 118.

When supplier N is ready to into a transaction with a customer 124 (which may be, relative to the particular value chain at issue, a higher-tier supplier, an OEM, a retailer, etc.), a smart contract 104 will be populated and executed. This smart contract may be based on the same form of smart contract as smart contract 112 (e.g., using the same inputs, having the same permissions, etc.) or may be different. Thus, blockchain network 110 may be customizable in the sense that the managing firm(s) can dictate which tiers and within the value chain will use which smart contract forms. By allowing a manager to dictate specific smart contract forms by tier, by role, or by participant, increased adherence to reporting requirements can be achieved.

Part of the input to smart contract 104 will include identifiers of past tokens that will be ‘utilized’ in the transaction. The result of smart contract 104 may include a new token that reflects an aggregation of past emissions. Thus, company 102 may allocate the emissions data received from the external supplier 108 to combine with emissions data produced by value chain supplier N−1 106, as inputs to the smart contract 104. This allocation can be done by the blockchain system 110 itself, according to an allocation percentage input by the company 102, such that the result of the smart contract 104 can include both a new token reflecting emissions of the product/service being sold as well as a new token reflecting the remaining emissions of the supplier token that were not attributed to the sale. In other embodiments, company 102 may initiate a division of the supplier token from supplier 108 (or any other supplier), so that smart contract 104 can consume or burn the sub-divided token entirely and the only output of smart contract 104 is the aggregated emissions token for the product/service being sold to company 124.

In some examples, blockchain 110 may be a private blockchain, accessible only to suppliers in value chain 100. In other examples, a supplier may be granted access to blockchain 110 only if they meet specified credentials or have received a certification. In some examples, the blockchain 110 can store information corresponding to emissions data of every supplier and/or entity involved in the value chain 100. The stored information can include data from suppliers within the value chain 100, data from external suppliers, or a combination.

As previously mentioned, the value chain supplier N−1 106 can use a smart contract to mint a token that represents emissions data from the (component) product at that point in the value chain. The value chain supplier N 102 may receive emissions data from the value chain supplier N−1 106 via a token minted by smart contract 112.

As previously mentioned, the value chain supplier N 102 can create tokens corresponding to emissions data of the value chain 100. In some examples, the smart contract 104 can help to incorporate emissions data of the supplier tokens stored in memory 118, as well as emissions data specific to the value chain supplier N's 102 emissions. For example, the functionalities of the processor 120 may contain metrics and data produced by any functions performed by value chain supplier N. Once smart contract 104 is executed, the newly minted token will be sent to the purchaser within the value chain 100, such as, value chain supplier N¬+1 122. In some examples, the value chain supplier N+1 122 can be an additional supplier that resources material or supplies from value chain supplier N 102. In other examples, value chain supplier N+1 122 can be one or more original equipment manufacturers and/or one or more retailers.

The tokens and smart contracts generated within value chain 100 may result in continuous updates to the enterprise databases of the participants affected by any given transaction, or updates may be run on a specified schedule. In some examples, blockchain 110 and tokens used as inputs to smart contracts 104, 112 may be updated automatically and immediately upon execution of smart contracts, while the generation of updated tokens and/or new tokens reflecting emissions data can be automatically/immediately as well or only after other following events/schedules dictate. In some examples, the tokens can be sent to entities outside of the value chain 100.

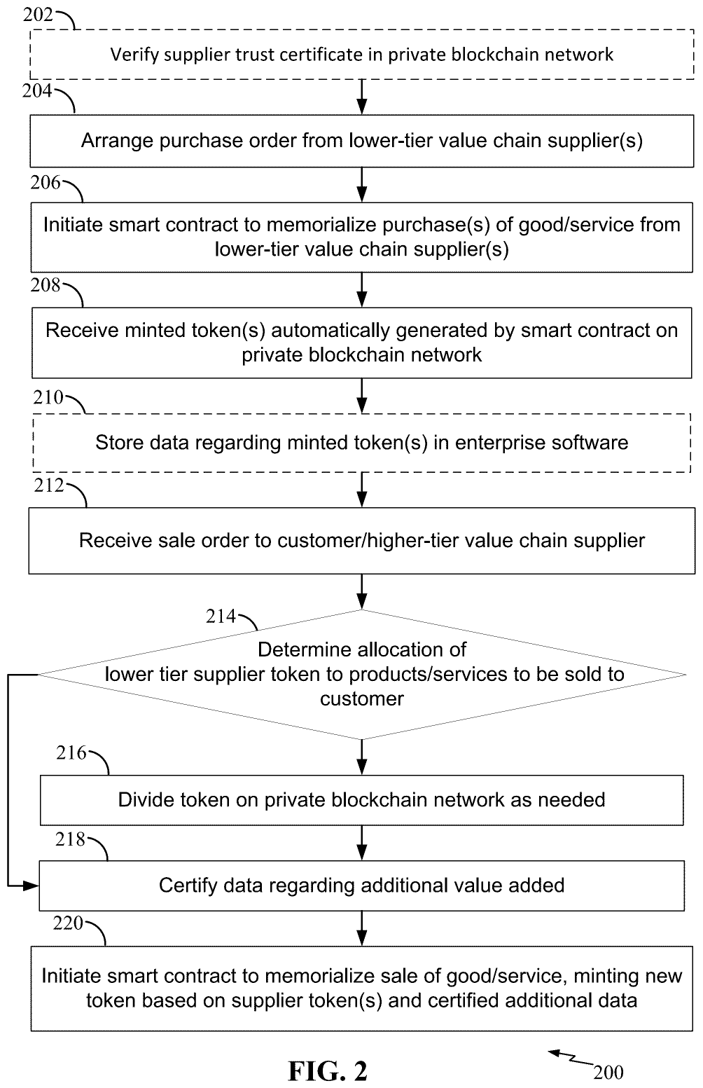

FIG. 2 is a flowchart illustrating an example process 200 for initiating a smart contract. As described below, a particular implementation can omit some or all illustrated features/steps, may be implemented in some embodiments in a different order, and may not require some illustrated features to implement all embodiments. In some examples, an apparatus (e.g., processor 120 with memory 118, etc.) in connection with FIG. 1 (described above) can be used to perform example process 200. However, it should be appreciated that any suitable apparatus or means for carrying out the operations or features described below may perform process 200.

At step 202, process 200 can optionally verify a supplier's trust certificate in a private blockchain network. In some examples, the verification can comprise a check of a supplier's identity (for example, via login credentials, a password, etc.). The trust certificate may identify the supplier's identity and any associated certifications corresponding to the supplier's approval and training regarding the use of the private blockchain network.

At step 204, process 200 can arrange a purchase order from one or more lower-tier value chain supplier(s). In some examples, the purchase order may contain information regarding how, when, and to what extent any emissions produced by the value chain supplier are to be attributed to the sale of the product/service. For example, data associated with emissions created from transportation, production, manufacturing, and other value chain activities can be attributed to a given product/service, a batch of products/services, a given shipment, a periodic total of sales, etc., and may be attributed so as to comply with regulatory standards for emissions tracking.

At step 206, process 200 can initiate a smart contract to memorialize one or more purchase(s) of goods and/or services from the one or more lower-tier value chain supplier(s). In some examples, a representation of the smart contract, or data representative of a token minted as a result of the smart contract, may be stored in a memory, such as memory 118 described above with respect to FIG. 1.

At step 210, process 200 can optionally store data regarding one or more minted token(s) in an enterprise software. In some examples, a minted token can be a non-fungible token (NFT). In some examples, the data stored in the token may correspond to emissions of one or more suppliers involved in the value chain process.

At step 212, process 200 can receive a sales order from a customer or higher-tiered value chain supplier. In some examples, the sales order can involve a good or material to be sent to the customer or higher-tiered value chain supplier. For example, the higher-tiered value chain supplier can be an original equipment manufacturer (OEM) that puts in a request (i.e., a sales order) for a material to be used in the OEM's own manufacturing process or value chain.

At step 214, process 200 can determine the allocation of a lower-tier supplier token to products and/or services to be sold to the customer. If a good or product used in fulfilling the sales order was sourced or contains goods or services obtained from a lower-tier supplier, the corresponding token can be allocated.

At step 216, process 200 can divide a token on a private blockchain network, as needed. In some examples, emissions data received from lower-tier suppliers may be divided into subgroups and incorporated into a new token, along with emissions data obtained by the supplier receiving the sales order.

At step 218, process 200 can certify any data regarding additional value added. In some examples, certification of data may be performed by requiring the supplier to provide data, sources, and other measurements associated with the data, or could involve requiring the supplier to obtain assurance on the processes it uses to track and report emissions (e.g., a System and Organization Control 2 (SOC2) Type II report).

At step 220, process 200 can initiate the smart contract to memorialize sales of goods and/or services. Moreover, a new token can be minted based on one or more supplier token(s) and any additional certified data.

### Systems and Methods for Value Chain Monitoring and Tracking

Next, the subject matter of the present disclosure will be described from the perspective of a company that controls, coordinates, monitors, and/or tracks other entities within a given value chain. The systems and methods described in this section may be useful for original equipment manufacturers, retailers, and other companies that may desire to have the advantages described below, such as a method for real-time tracking and report generation of emissions information.

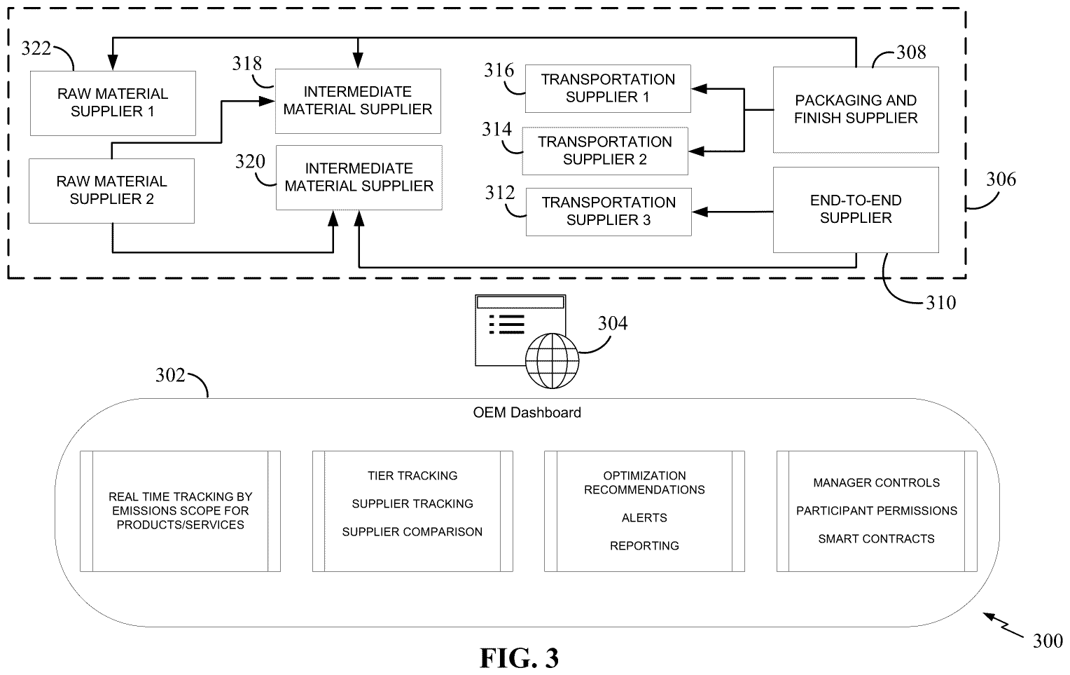

FIG. 3 is a block diagram illustrating various functionalities of an enterprise software 300 used for reporting emissions, according to some embodiments. A user may use enterprise software 300 to receive and transmit information to and from one or more suppliers 306. For example, an OEM may use enterprise software 300 to report value chain information arising from or relating to suppliers and/supplier activities, such as raw material suppliers, intermediate material suppliers, transportation suppliers, packaging and finishing suppliers, and/or end-to-end suppliers. Receiving and transmitting of information may be performed via a blockchain 304. In some examples, blockchain 304 may correspond to or have similar functionalities and attributes to blockchain 110, as described above with respect to FIG. 1.

Based on information received from suppliers 306, an OEM dashboard 302 can provide a user or entity with various functionalities and reports. (It should be understood that references herein to “OEM dashboard” may, depending on context, also be understood to refer to a manager dashboard or other interface by which a managing firm or firms can monitor and control an instance of a permissioned blockchain system as described herein.) In some examples, the OEM dashboard 302 can allow for real time tracking by emissions scope for one or more products and/or services. For example, a user may be able to see aggregated, current emissions data associated with a product being manufactured, in real time. This information can be drawn simply from the permissioned blockchain system at a given tier or from a given supplier. For example, if a supplier N purchases materials and services from upstream suppliers (e.g., N−1, N−2, etc.) smart contracts executed as a result of those purchase transactions (and/or their resulting tokens or NFTs) can be stored in the permissioned blockchain that is the subject of dashboard 302 in association with information identifying what product or service will be sold downstream by the supplier N. In other words, the blockchain representation of a transaction can not only reflect the transfer of aggregated emissions information, but also information descriptive of the purpose for which the underlying goods/services will be utilized within the overall value chain. Thus, a given supplier's inputs can be ascertained via dashboard 302, which can be indicative of current emissions on a product level basis. In other embodiments, retrospective analysis of emissions for a given product line (or even a given unit of a product) can be done via dashboard 302. For example, as each smart contract is recorded in the blockchain ledger, information regarding its inputs can also be stored. In this manner, a manager or OEM can backtrack through the value chain to determine how and to what extent emissions were accumulated. In some embodiments, certain sensitive business information can be obfuscated to some or all users, such as the identity of suppliers that are more than a given number of tiers away from the dashboard user; information concerning the specifications and/or nature of the goods/services being sold which generated the emissions data; pricing, etc.

In further examples, the dashboard 302 can allow for tier tracking, supplier tracking, and/or comparisons between suppliers. For example, a user may be able to compare emissions metrics between similarly-situated or competitive suppliers among the group of value chain suppliers 306. In this manner, managers and higher-tier suppliers who may be given access to dashboard 302 can leverage verifiable emissions information to rate or rank alternative suppliers, and identify underperforming suppliers and/or underreporting suppliers. As another example, a user of the OEM dashboard 302 may be able to generate on-demand life cycle assessments to view the environmental impact over the course of an entire life of a product.

Moreover, in some examples, the OEM dashboard 302 can produce optimization recommendations, alerts, and/or reporting. For example, an optimization recommendation may include suggestions directed toward using a specific supplier from among a group of suppliers 306 to execute a task within a specific product's value chain, or to eliminate or rearrange steps in a value chain that consistently have a higher emission rating relative to value. In other examples, an alert may be triggered if the total emissions generated in a value chain approaches or exceeds a specified threshold value, or deviations occur such as emissions levels trending upward or downward for given tiers, suppliers, or functions within the value chain. The dashboard 302 can use information obtained from blockchain 304 to perform the above-mentioned functionalities. In some examples, the OEM dashboard 302 can use data derived from blockchain 304 to generate other types of alerts and/or reports. For example, the OEM dashboard may allow a user to determine if any alerts or reports should be generated when an update is made to the blockchain 304 by one or more of the suppliers 306, such as an alteration to a smart contract form, the addition or removal of participants, etc. In other circumstances the OEM dashboard may generate an alert if undesirable increases or other changes to emissions occur relative to past performance.

In yet further circumstances, the OEM dashboard may interface with monitoring processes that improve trustworthiness and verifiability of emissions reports, such as processes that detect inaccurate information being provided by participants, or utilize public sources to determine authenticity of a given participant's information submissions. For example, where a participant is a public company or otherwise generates annual reports and similar financial statements, the OEM dashboard may monitor content of those reports (e.g., using natural language processing or a large language model) to determine if the company may be underreporting the suppliers it uses. For example, if a public financial statement indicates that a major supply contract was signed with a raw material provider or co-packer, but that supplier does not show up in a ledger participant's reporting of its emissions, the OEM dashboard could generate an alert for a user to follow up with the company and determine the source of the discrepancy.

In another manner, comparisons between similarly situated suppliers can be used to reveal underreporting, overreporting, or missing information. For example, assume that two intermediate material suppliers 318, 320 both provide a fungible, or essentially fungible, good or service to a downstream supplier, and both purchase raw materials from the same upstream raw material supplier 2. When intermediate material supplier 318 sells its good or service, it usually ‘burns’ seven tokens representing emissions of upstream suppliers, in addition to reporting its own emissions data. However, when intermediate material supplier 320 sells what is essentially the same good or service, it usually ‘burns’ only one or two tokens representing emissions of its upstream suppliers, in addition to reporting its own emissions data. Dashboard 302 may interface with a monitoring process that detects this discrepancy and provides an alert to the dashboard user to investigate why the discrepancy is occurring. For example, one supplier may be underreporting emissions, or the other supplier may be operating inefficiently. When a pattern of this discrepancy is detected, the OEM dashboard can likewise generate an alert to signal possible underreporting or overreporting. In this manner, an additional layer of trust can be achieved (and promoted) through use of the systems disclosed herein.

In some embodiments, dashboard 302 may be a manager dashboard, that controls aspects of a private blockchain ledger 304 through which its various suppliers 306 receive, report, and mint tokens regarding emissions. The dashboard 302 may, thus, provide for a number of additional functionalities that are only available to the managing firm(s) of the blockchain. These functionalities may include: setting certification criteria for any given supplier throughout the value chain to be admitted into the blockchain platform (which may include, for example, third-party verification that all categories of Scope 1, 2, and 3 emissions are being properly accounted for and tracked); removing suppliers that fail to adhere to the system; updating certification criteria as emissions reporting standards change; viewing each individual transaction and associated token(s) within the value chain; communicating with the supplier users directly; requiring certain participants in the ledger to use smart sensors or other IoT devices to generate and track emissions data; etc.

### Design Principles and Challenges to Overcome

Various governmental laws and regulations have emerged (such as the SEC's 2022 Proposed Rule, The Enhancement and Standardization of Climate-Related Disclosures for Investors (herein, the “Proposed Rule”), which generally require certain types of companies to report upstream and downstream emissions from their value chain. To better understand the challenges of tracking and reporting these emissions, the inventors reviewed a targeted sample from the more than 15,000 comment letters written in response to the Proposed Rule. In doing so, letters from parties were selected that (1) are heavily affected by the disclosure requirements given their industry, (2) may provide assurance, legal, or compliance advice on the disclosures, or (3) may use the disclosures in capital allocation decisions. These comments were used by the inventors to derive underlying causes of difficulties, capabilities, obstacles, and needs relating to the existing state of the field pertaining to how resources and impacts (like emissions) were tracked and managed.

The inventors then developed design principles for the solutions described herein, which included first-order concepts and second-order themes for a technology-driven solution, as further described herein. In some embodiments, first-order concepts were grouped into five second-order themes that represent challenges firms face in adhering to a reporting or tracking requirements (such as the Proposed Rule), that can be resolved with a technology-driven solution. The second-order themes are as follows: (1) obtaining reliable data on common factors of each member of a value chain (especially Scope 3) is difficult, (2) firms are unprepared to meet tracking and reporting requirements, (3) congruent and expedited reporting of financial and non-financial metrics, (4) exposure of confidential commercial information, and (5) unintended consequences and adverse effects for public and private firms.

As described below, the various embodiments described herein provide solutions to these challenges in a comprehensive, coordinated, real-time, and verifiable manner. The use-case of emissions tracking (e.g., as may be required for compliance with the Proposed Rule) is utilized at times in the following discussion as an example. However, the fundamental principles and configurations of various embodiments described herein are also applicable to other use-cases, such as social impact factors (e.g., hiring practices), community impact, resource usage, other environmental impacts, and the like.

Obtaining Reliable Emissions Data: The value chains for most firms are complex. For example, while some firms may already attempt to track and report Scope 1 and 2 emissions, providing reliable Scope 3 data is an especially challenging task that places a daunting burden upon these firms. This is due, in part, to the difficulty of identifying all emissions sources and parties throughout the value chain, obtaining emissions data from each, and determining whether these data are accurately measured. In some circumstances, this data could be especially hard to obtain from private firms or those located in foreign jurisdictions that are not under the purview of the SEC. As a result, firms may be forced to apply significant judgment and bear the costs to estimate Scope 3 emissions (i.e., secondary data) that are presumably less reliable than had this information been obtained directly from the emitting firm (i.e., primary data). However, even when firms are able to obtain emissions information directly from value chain participants, questions remain about data reliability. Finally, while assurance may enhance the reliability of emissions data, commenters believe that few assurance providers are qualified and prepared to perform this work.

As described above with respect to FIGS. 1-3, however, the systems and methods disclosed herein allow for a consistent way for data to be reliably obtained. This is an advantage achieved through at least two novel facets of the present disclosure: a managed/private blockchain platform (or equivalent) is utilized, whereby each participant in a value chain provides data according to a consistent, certified, and auditable approach (for example, this can be a required criterion for being within a given value chain); and the data contributed by each firm within the value chain is reported by an immutable token (e.g. a blockchain token) that can be verified by other members of the platform and is reflective of the allocated data of each firm upstream in the value chain.

Firms are Unprepared to Meet the Proposed Requirements: The Proposed Rule requires firms to track and report emissions from seven greenhouse gases (SEC 2022). In doing so, firms must convert each gas into metric tons of CO₂ equivalents (CO₂e) which serves as “the common unit of measurement to indicate the global warming potential (“GWP″) of each GHG, expressed in terms of the GWP of one unit of carbon dioxide” (SEC 2022, 478). Furthermore, an emission can be classified as Scope 1 or 2 by only one firm, yet the same emission can be reported by many different firms as Scope 3 (across various categories). Firms will therefore need to have mechanisms in place to measure and convert emissions to CO₂e, identify other firms' relevant Scope 1 and 2 emissions, and then classify these other firms' emissions into appropriate Scope 3 categories.

Commenters feel unprepared to adhere to the Proposed Rule, particularly with Scope 3 emissions. They insist it would be difficult to modify existing roles, processes, and/or technologies to meet the demands of the Proposed Rule, and assert that doing so would necessitate substantial investments in people, processes, and technologies. As such, many firms ask for a delayed implementation, particularly for requirements related to tracking and reporting Scope 3 emissions. Some even encourage the SEC to limit the reporting of Scope 3 emissions to upstream value chain parties (i.e., suppliers) from which emissions data might be more readily available.

However, by having a centralized management of emissions reporting (e.g., via the managed blockchain platform), all data can be reported in a consistent manner in an easy and verifiable way. And, the determination of whether a given emission is Scope 1, 2, or 3 can be delegated to the system itself, rather than based on individual decisions made by disparate members of a value chain.

Congruent and Expedited Reporting of Financial and Non-financial Metrics: The Proposed Rule requires emissions data to be reported in Form 10-K contemporaneously and congruently with traditional financial disclosures. However, current emissions tracking and reporting processes simply cannot provide the information in a timely manner, particularly the 60-day reporting window for large, accelerated filers. As such, they insist the Proposed Rule would cause filing delays of their Form 10-K. In addition, a confounding problem in rapid reporting is that not all participants in a given value chain follow the same reporting calendar or method, such that the lack of alignment makes it difficult to gather the data on a timely basis. For example, if indirect emissions data are not available within the time allotted, firms would be forced to report estimated rather than actual emissions.

By utilizing the methods described herein, smart contracts can automatically mint tokens that can be verified and reviewed by all members of a value chain. Thus, real-time access to data indicative of emissions is achieved, on a product, batch, or business line level.

Exposure of Confidential Commercial Information: One current obstacle to efficient tracking is the concern that some firms may need to expose trade secrets in the form of their choices of suppliers. For example, the Proposed Rule's Scope 3 emissions reporting requirements could lead to the exposure of confidential commercial information. Specifically, a firm's source of goods or services oftentimes represents a competitive advantage, and naming these parties to meet reporting requirements could lead to disclosing competitively sensitive information. For this reason, some suppliers and customers may be unwilling to share emissions data, or at least to share full emissions data.

However, by employing a centralized platform in which all participants in a value chain have certified compliance with given data collection and reporting standards, they can submit their emissions data in an effectively confidential manner. For example, each given supplier or firm within a value chain can allocate a portion of the tokens obtained through smart contracts with their own suppliers, add their own emissions contributions (per the certified standards), and mint a new token. Other viewers of that token can be: (a) limited to other participants in the value chain, because the platform can be made private or semi-private (e.g., a given OEM or given retailer may host the platform, or an instance or group of members on the platform, for all of its suppliers); and/or (b) limited to the recognition that the upstream supplier tokens combined with the current supplier's own emissions information were verified (but not who originated them or how they were originated).

Unintended Consequences and Adverse Effects for Public and Private Firms: Additionally, another obstacle to overcome is a perception that there could be unintended consequences and potential adverse effects for both public and private firms if a consistent reporting process were adopted. For example, an increased cost of compliance for public firms, could discourage private firms from going public. Further, the Proposed Rule risks disproportional effects for firms with larger or more complex value chains, and it might discourage public companies from contracting with small or less resourceful entities. For example, a large public company may choose to only contract with other large public companies subject to the same requirements because doing so ensures their value chain partners have adequate systems to track and report emissions. Unfortunately, this decision could disadvantage smaller or private firms that lack the resources and sophistication of large public firms.

However, the embodiments described herein can overcome this problem, by limiting what any given firm within a value chain would need to do. In other words, each firm within a value chain does not need to verify or track emissions information from any of its own suppliers, as that data would be added to the private ledger in a verifiable way by each of those suppliers themselves. Then, the given firm could simply query the blockchain ledger for a specific product and see the lineage of emissions associated with that product (i.e., based on the lineage of the token(s) the firm received and/or released related to that product).

Additional Motivation to Improve Emissions Tracking and Reporting: While the challenges above help motivate the proposed solution, several additional factors serve as motivation. For example, more credible and detailed emissions reporting enables firms to compete not only on the price and quality of goods but also on their environmental impact. Such information will likely create broader accountability for upstream suppliers and downstream parties and may increase demand for products with a demonstrably lower environmental impact. From a regulatory perspective, “ . . . governments are expected to set new policies and provide additional market-based incentives to drive significant reductions in emissions. These new policy and market drivers will direct economic growth on a low-carbon trajectory” (GHG Protocol 2011a, 3). As this happens, more widely available and credible emissions information can help investors make more informed decisions (SEC 2022). Firms that rely heavily on carbon-intensive inputs might experience a decrease in the demand for their products unless lower-carbon inputs are identified (SEC 2022). More robust emissions reporting will also help stakeholders identify when a firm chooses to outsource functions to avoid reporting higher levels of Scope 1 or 2 emissions (SEC 2022). Finally, better information on Scope 3 emissions can help firms control their environmental impact, as it “enables companies to understand their full emissions impact across the value chain and focus efforts where they can have the greatest impact” (GHG Protocol 2011a, 5-6).

### Design Solutions and Example Embodiments

To define certain overall objectives of a proposed solution, the inventors aimed to ensure that the tracking and reporting of emissions across a value chain would solve the challenges of collecting and tracking each party's relevant emissions. With this goal, in some embodiments, system attributes can be thought of as achieving five objectives, one for each challenge identified above. Accordingly, a given embodiment may: (1) Improve the availability and reliability of emissions data without placing an undue burden on participants, (2) Standardize emissions tracking and reporting using an inter-firm technology platform, (3) Provide verified emissions data across a value chain in near real-time, (4) Protect participants' confidential commercial information, and (5) Streamline the tracking and reporting of emissions data for firms of all sizes and types.

Guided by the defined objectives and review of prior research, the inventors determined that the specific use of blockchain, NFTs, and smart contracts to track emissions throughout a value chain at the unique product level serves as a useful framework. The handshake/transfer of unique emissions between parties at the product level and demonstrating how NFTs representing unique products and emissions can be used by firms to track and report Scope 1, 2, and 3 emissions. As described herein, this transfer of NFTs (aided by smart contracts) is a useful component in some implementations and/or from some perspectives for establishing a reliable and complete provenance of emissions across a value chain.

In some implementations, systems managing a private platform can govern the creation of NFTs that carry emissions data at the unique product level, how these NFTs integrate into the blockchain ecosystem and transfer between parties as distinguishable Scope 1, 2, and 3 emissions, how NFTs are added to in-process products, how legacy NFTs are decommissioned and removed from circulation, how smart contracts act on information from the physical world to transfer the NFTs, and how this ecosystem comes together to provide a reliable provenance of emissions that can be classified into Scope 1, 2, and 3 categories by all participants in a value chain.

In some embodiments, a permissioned consortium blockchain can be utilized, meaning a given OEM, retailer, or consortium of firms can be explicitly granted access to run and maintain the blockchain ecosystem. For example, in some embodiments, a public company that is a top-of-value chain or near the top, can manage the permissioned consortium blockchain. The public company may host participant portals and govern access by suppliers to the blockchain, or may subscribe to a third-party service provider to implement a private blockchain for the public company's use.

In some implementations, the managing firm(s) are the only firms permitted to view the underlying ledger of transactions and events, but it is conceivable that certain others (e.g., governments, regulators, auditors) might be granted view-only access to this data. Such a private blockchain may allow for the managing firm(s) to have a strong governance mechanism, including policies and procedures that dictate how to operate and maintain the blockchain. For example, rules could be established by the managing firm(s) that dictate how new parties are approved to participate in the consortium, how and why parties are removed, and how the consortium addresses technical changes to any underlying protocols and consensus requirements.

In some embodiments, the managing firm(s) may dictate specifications for identifying all relevant sources of emissions, the measurement or estimation of emissions from these sources, and procedures for certification, independent verification, or other means of establishing that the parties to be admitted to participation in the ledger have systems in place to track such data. For example, the GHG Protocol identifies 15 categories of Scope 3 emissions (GHG Protocol 2011a), and in some embodiments, the managing firm(s) can require trust verification that all suppliers in a value chain are equipped to track those categories before being able to participate in the ledger (and, the managing firm(s) can require their own tier 1 suppliers to adhere, including that the tier 1 suppliers will require their own tier 2 suppliers to adhere, and so forth).

As an example, one can consider a manufacturing value chain that produces a final product rather than an intermediate product that requires further downstream processing. One can also assume that the value chain reflects the stages of a product from “material acquisition through to end-of-life” (GHG Protocol 2011b, 134) and that all participants report all applicable emissions to the blockchain and follow an agreed-upon approach to define their organizational boundaries and to consolidate emissions (e.g., based on equity share, financial control, or operational control) (GHG Protocol 2011a). Finally, one can assume that participants have reliable processes in place to (1) allocate Scope 1 and 2 emissions to unique assets using methods similar to those when allocating/assigning labor, materials, and overhead costs to inventory items, and (2) estimate emissions from the product's use and end-of-life treatment (e.g., disposal, reuse, or recycle) (GHG Protocol 2011b).

Taking into account the foregoing design goals and assumptions, a blockchain solution was designed to track and report emissions across a value chain. Recall that to track Scope 3 emissions, participants must report their own Scope 1 and 2 emissions to the blockchain. As such, the proposed solution demonstrates how to incorporate Scope 1 and 2 emissions into the tracking and reporting of Scope 3 emissions.

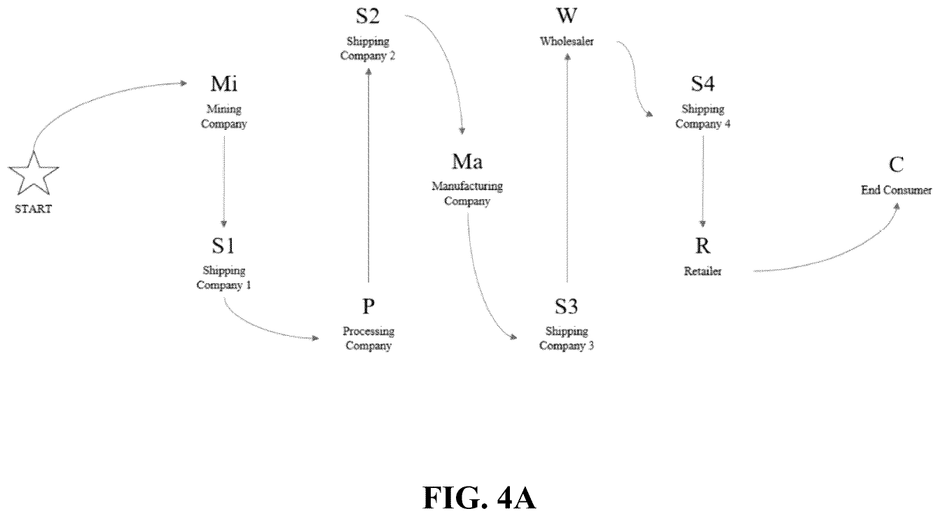

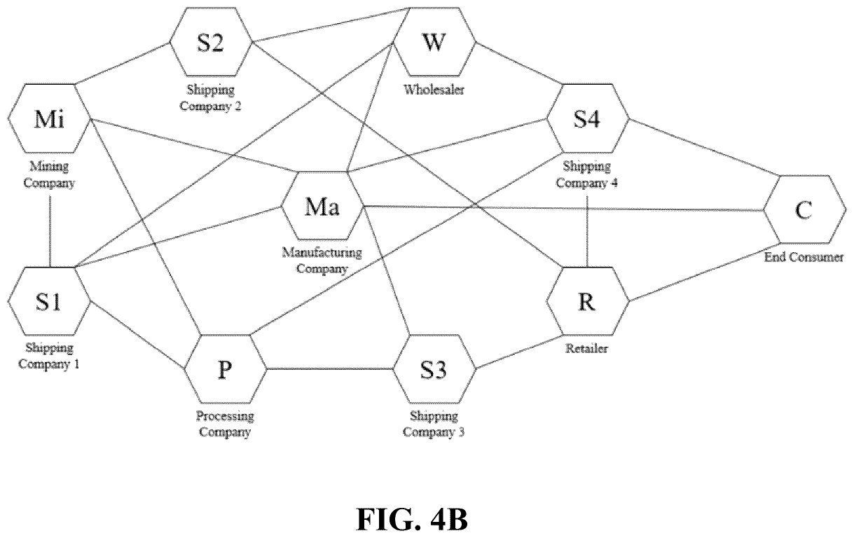

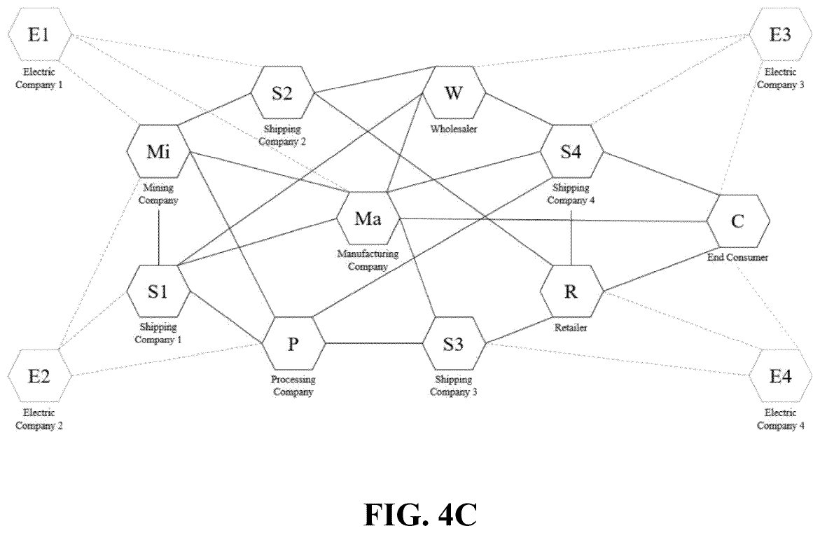

Example Design: As indicated above, a challenge in reporting value chain emissions is tracking these across both upstream suppliers and downstream customers/consumers. Currently, the most readily available information about value chain participants' emissions comes from those parties adjacent to a firm in its value chain, as products and information tend to flow through the chain, with parties only having access to information when directly involved in an exchange or transaction. Panel A in FIG. 4 presents this ontology, with a one-way flow of information through typical members of a manufacturing value chain. However, with blockchain, participants share a common ledger, meaning that with the proper permissions, each party can view the history of recorded events and transactions. Panel B in FIG. 4 presents this sharing of information in a blockchain ecosystem, using the same parties (in the same positions) as Panel A. Here, value chain participants are represented with hexagons, a symbol commonly used to indicate a party's participation as a node (i.e., computer or server) in a blockchain network. Of note, all parties are at least indirectly linked in this distributed network. With the appropriate permissions, all parties can communicate and share information, even those without a direct link to a specific participant (e.g., the Retailer and Extraction Company). Finally, Panel C in FIG. 4 expands upon Panel B by showing how electric companies (or any other company serving as a source of energy) used by value chain participants can participate in sidechains (i.e., blockchains that link to a parent blockchain), thus providing the blockchain with a mechanism to directly record participants' consumption of energy (i.e., Scope 2 emissions).

Smart contracts and NFTs are examples of tools for a permissioned consortium platform to track and record the provenance of emissions. However, it should be noted that other mechanisms for initiating the transfer of emissions allocations can also be utilized. For example, private digital keys and other verification methods can be used to allow participants to upload data into a database managed by the managing firm(s). The data can be ‘transferred’ to another participant's account upon reporting a transaction, and data from multiple lower-tier suppliers can be used to generate a cumulative representation of emissions that is ‘transferred’ to a downstream participant's account upon a subsequent transaction. By having all of the data housed within a system governed by the managing firm(s), the managing firm(s) can control and monitor reporting of data.

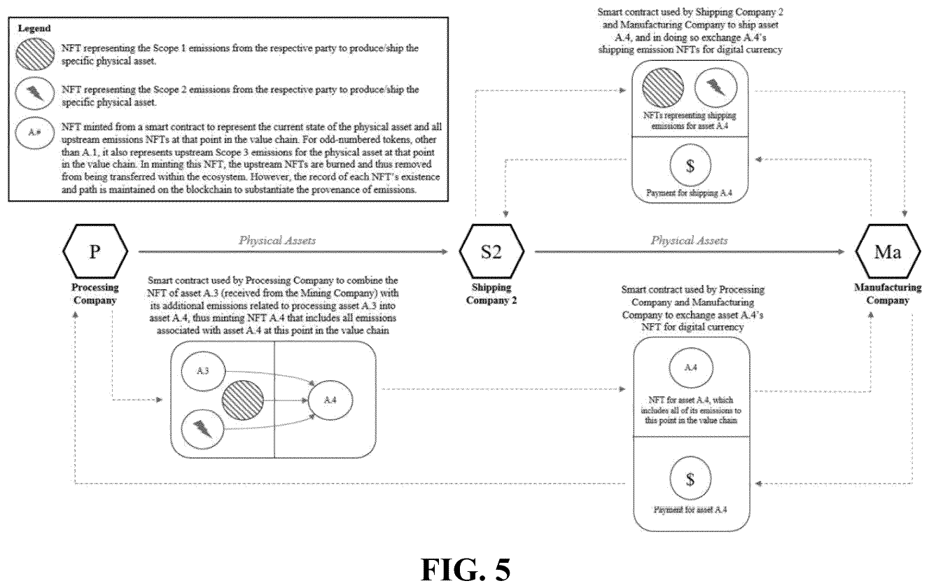

Using the same manufacturing value chain presented in FIG. 4, FIG. 5 illustrates the use of smart contracts and NFTs to track emissions by focusing on exchanges between Processing Company, Shipping Company 2, and Manufacturing Company. Here, Processing Company holds the NFT used to represent a specific and unique physical asset, A.3, which it received as the result of an earlier exchange with Extraction Company. The NFT for asset A.3 is also unique in that it includes information on emissions related to asset A.3 accumulated up to that point in the value chain. None of these emissions originated from Processing Company, so they are Scope 3 from its perspective. Processing Company then applies work to further process asset A.3, which involves generating emissions at its own facilities (i.e., Scope 1) and at a regional utility company that provides electricity (i.e., Scope 2). When finished processing asset A.3, Processing Company uses a smart contract to combine A.3's NFT with two other NFTs it minted to allocate Scope 1 and Scope 2 emissions to asset A.3. The smart contract combines the information from these three NFTs to mint a new NFT that represents the updated physical asset and its aggregated emissions up to this point in the value chain, and thus iterates its identifier to A.4 (this process is examined in greater detail below). When Processing Company sells asset A.4 to Manufacturing Company, a smart contract acts as an automated escrow between the two parties, holding the NFT for asset A.4 (provided by Processing Company) as well as payment for the asset (provided by Manufacturing Company). Here, the smart contract can be set up to settle once evidence is provided to the blockchain that the physical asset A.4 arrived at Manufacturing Company's receiving dock. Assuming that Manufacturing Company pays for shipping and takes legal possession of A.4 upon physical arrival, it will also establish a smart contract with Shipping Company 2. Here, a smart contract holds Shipping Company 2's NFTs related to its Scope 1 and Scope 2 emissions from shipping asset A.4, as well as payment for shipping from Manufacturing Company. After the smart contract obtains evidence that asset A.4 arrived at Manufacturing Company, it will execute and release payment to Shipping Company 2 and the shipping emissions NFTs to Manufacturing Company.

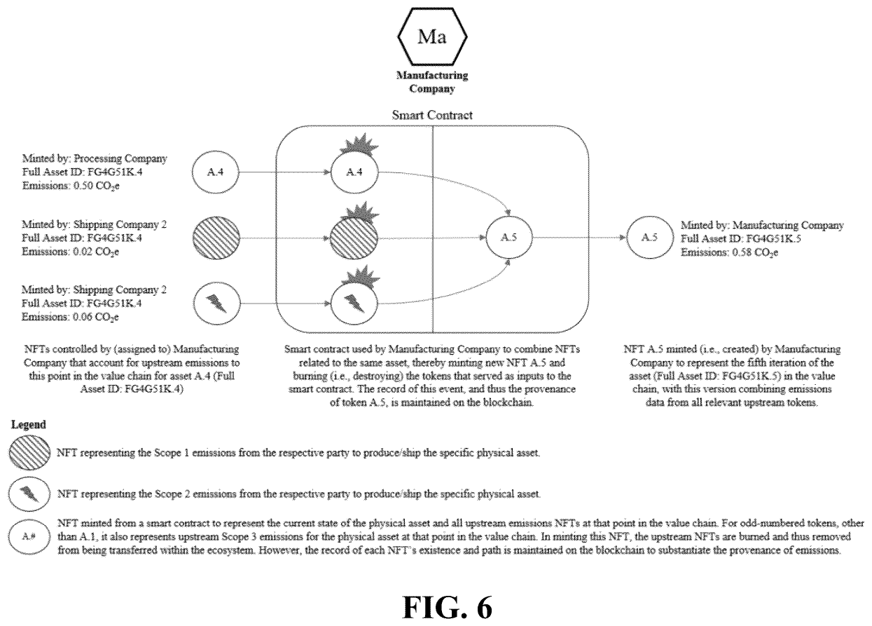

At this point, Manufacturing Company has received three NFTs related to asset A.4. The first NFT came from Processing Company and represents the acquired physical asset A.4, which includes all upstream emissions related to the asset up to this point in the value chain. Then, two more NFTs came from Shipping Company 2 to represent its Scope 1 and Scope 2 emissions from shipping asset A.4. To simplify emissions tracking, Manufacturing Company inputs these three NFTs into a smart contract to mint a single NFT, A.5, to represent all upstream emissions (i.e., Scope 3) from the asset at this point in time. In minting A.5, the smart contract burns the three input NFTs to avoid risks of double counting the associated emissions (which are now recorded in NFT A.5). Sec FIG. 6 for an illustration of this process. While burning the three input NFTs removes these tokens from circulation in the ecosystem, their cradle-to-grave provenance remains recorded as part of the blockchain ledger. As discussed below, this sustained record of each NFT's provenance is essential for blockchain to accurately track and report the Scope 1, 2, and 3 emissions.

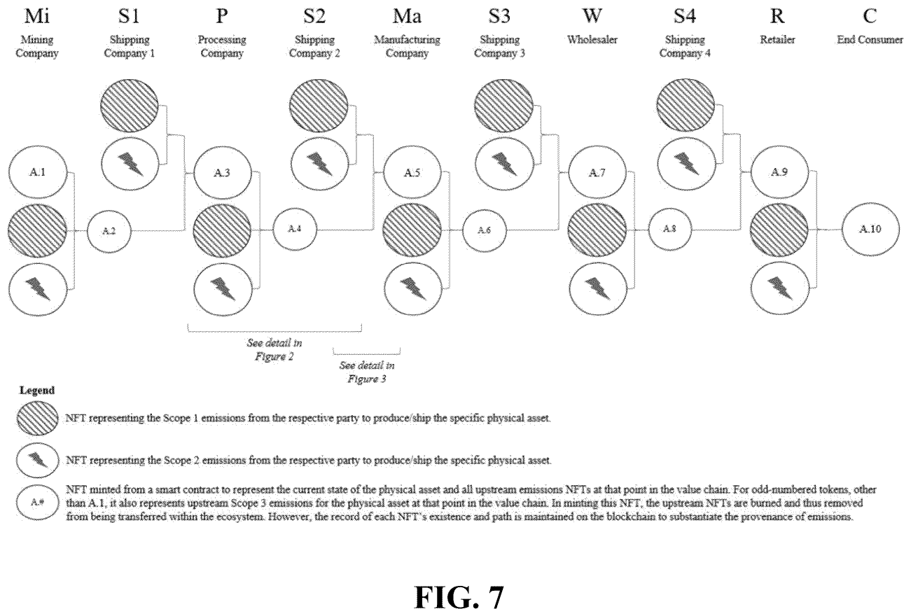

If the processes described above are applied across the entire manufacturing value chain, the flow of tokens should appear as presented in FIG. 7. Here, the minting and burning of NFTs (enabled by smart contracts) create a cradle-to-grave, fully linked, agreed-upon, shared provenance of emissions and allows all parties to examine the source of emissions assigned to a specific asset. As shown, iterations of asset A. # move through the value chain and accumulate emissions information that can be classified as Scope 1, 2, or 3, depending on the reporting firm. Furthermore, because blockchain creates a (temporally) linear record, participants can query the ledger for a defined time period to report their Scope 1, 2, and 3 emissions. For example, in FIG. 7, Manufacturing Company can trace the upstream and downstream emissions linked to asset A.5. Here, NFT A.5 represents all upstream emissions for the asset. In contrast, A.10 represents all emissions accumulated to put the asset in the hands of an end-consumer (including estimates of emissions from its use and end-of-life treatment). Manufacturing Company's emissions reporting for this specific asset becomes a function of the following: Scope 1 Emissions=Manufacturing Company's Scope 1 NFT, Scope 2 Emissions=Manufacturing Company's Scope 2 NFT, Scope 3 Emissions=A.10−Scope 1 Emissions−Scope 2 Emissions, Downstream Emissions=A.10−A.6. Upstream Emissions=A.5.

Any reporting firm can apply a similar approach and have readily available access to Scope 1, 2, and 3 emissions information in the manufacturing value chain. For instance (again referencing FIG. 7), Wholesaler's emissions reporting would appear as: Scope 1 Emissions=Wholesaler's Scope 1 NFT, Scope 2 Emissions=Wholesaler's Scope 2 NFT, Scope 3 Emissions=A.10−Scope 1 Emissions−Scope 2 Emissions, Downstream Emissions=A.10−A.8, Upstream Emissions=A.7.

This proposed solution can also determine Scope 3 emissions by category when any participant is the reporting firm. It is also presented how the various firms can use the NFTs created in the manufacturing value chain to determine and report their Scope 3 emissions by category. Notably, it is demonstrated how each Scope 3 category would be calculated using the NFTs from FIG. 7 (i.e., A. #) and does so through the lens of each firm as the reporting firm.

Experiments and Evaluation: As it relates to the burdens that the Proposed Rule places upon firms and whether the solution alleviates them, one consideration is how the proposed solution compares to the processes companies would otherwise use for tracking and reporting Scope 3 emissions.

One design goal contemplated by the inventors, is to ensure that the system is clear, transparent, easy to use, consistent, verifiable, and reliable. It is clear from the inventors' research that companies are currently ill-equipped to track and report Scope 3 emissions in such a manner.

Another design goal is the rapidity of generating a reliable result. For example, based on the inventors' research, the 60-day reporting window provided in the Proposed Rule is likely viewed as simply unfeasible by most companies using their current systems. However, transactions in a blockchain ecosystem are quickly verified, validated, and added to the permanent ledger (i.e., the ledger records near real-time updates). As such, the solutions presented herein allow for expedited emissions aggregation and reporting that, in many cases, will be quicker than the aggregation and reporting of a firm's financial information. This also means the solution makes emissions information available for reporting within the Form 10-K deadline. By uniquely identifying each participant's emissions, the solution allows for near real-time aggregation and reporting of emissions as a product makes its way through the value chain.

Another aspect of the appeal of using blockchain to track and report emissions is that it allows participants to maintain a transparent ledger in a distributed environment. Yet, this same transparency and replication can concern firms not wanting to disclose competitive information about their business partners and the scale or frequency of certain transactions. Thus, the use of a consortium blockchain whereby members are explicitly approved to participate, means only permissioned members can maintain a copy and view the contents of the ledger. Furthermore, the ability to read and write content is restricted to pre-authorized areas of the blockchain.

As it relates to the concern that the Proposed Rule would have unintended consequences, such as negative impacts on smaller, private firms, and that it might encourage public companies to exclude “mom-and-pop” companies because of their lack of resources or inability to reliably track and report emissions, the proposed solution would streamline the tracking and reporting of emissions for firms of all sizes and types. While smaller and private firms might still need to join the blockchain ecosystem and agree to work within established parameters around how they report emissions, the reporting could be automated via smart contracts and embedded into their already established billing and payment processes. It is also believed that this alleviates some of the concerns around firms excluding less sophisticated parties from their value chain. The proposed solution minimizes this risk by offering a distributed technology that less sophisticated firms can implement, allowing them to remain value chain partners with the firms required to meet the demands of the Proposed Rule.

### Example Hardware Implementation System

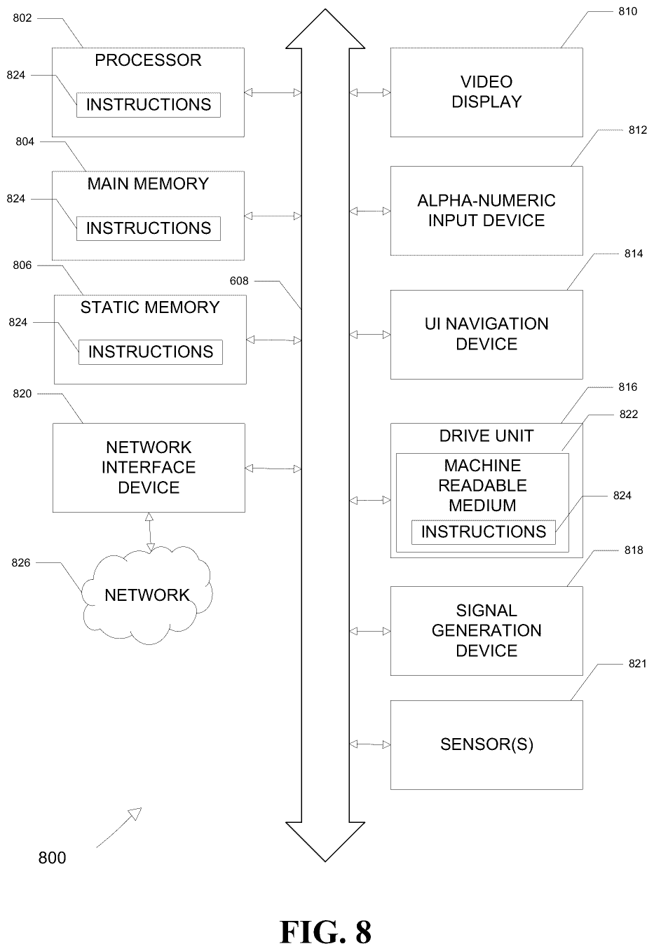

FIG. 8 is a block diagram illustrating an example of a machine upon which one or more aspects of embodiments of the present invention can be implemented. Referring to FIG. 8, an aspect of an embodiment of the present invention includes, but not limited thereto, a system, method, and computer readable medium that provides: a) using Blockchain, NFTs, and smart contracts to track and report greenhouse gas emissions, b) using NFTs in passing unique emissions between firms, whereby smart contracts may aid in these exchanges, c) using the blockchain ecosystem in creating an environment where all emissions can be accounted for, and/or d) using the cradle-to-grave provenance of emissions recorded in a linear manner that is capable of being verified and agreed upon by members or other users of the blockchain, which illustrates a block diagram of an example machine 800 upon which one or more embodiments (e.g., discussed methodologies) can be implemented (e.g., run).

Examples of machine 800 can include logic, one or more components, circuits (e.g., modules), or mechanisms. Circuits are tangible entities configured to perform certain operations. In an example, circuits can be arranged (e.g., internally or with respect to external entities such as other circuits) in a specified manner. In an example, one or more computer systems (e.g., a standalone, client or server computer system) or one or more hardware processors (processors) can be configured by software (e.g., instructions, an application portion, or an application) as a circuit that operates to perform certain operations as described herein. In an example, the software can reside (1) on a non-transitory machine readable medium or (2) in a transmission signal. In an example, the software, when executed by the underlying hardware of the circuit, causes the circuit to perform the certain operations.

In an example, a circuit can be implemented mechanically or electronically. For example, a circuit can comprise dedicated circuitry or logic that is specifically configured to perform one or more techniques such as discussed above, such as including a special purpose processor, a field programmable gate array (FPGA) or an application-specific integrated circuit (ASIC). In an example, a circuit can comprise programmable logic (e.g., circuitry, as encompassed within a general-purpose processor or other programmable processor) that can be temporarily configured (e.g., by software) to perform the certain operations. It will be appreciated that the decision to implement a circuit mechanically (e.g., in dedicated and permanently configured circuitry), or in temporarily configured circuitry (e.g., configured by software) can be driven by cost and time considerations.

Accordingly, the term “circuit” is understood to encompass a tangible entity, be that an entity that is physically constructed, permanently configured (e.g., hardwired), or temporarily (e.g., transitorily) configured (e.g., programmed) to operate in a specified manner or to perform specified operations. In an example, given a plurality of temporarily configured circuits, each of the circuits need not be configured or instantiated at any one instance in time. For example, where the circuits comprise a general-purpose processor configured via software, the general-purpose processor can be configured as respective different circuits at different times. Software can accordingly configure a processor, for example, to constitute a particular circuit at one instance of time and to constitute a different circuit at a different instance of time.

In an example, circuits can provide information to, and receive information from, other circuits. In this example, the circuits can be regarded as being communicatively coupled to one or more other circuits. Where multiple of such circuits exist contemporaneously, communications can be achieved through signal transmission (e.g., over appropriate circuits and buses) that connect the circuits. In embodiments in which multiple circuits are configured or instantiated at different times, communications between such circuits can be achieved, for example, through the storage and retrieval of information in memory structures to which the multiple circuits have access. For example, one circuit can perform an operation and store the output of that operation in a memory device to which it is communicatively coupled. A further circuit can then, at a later time, access the memory device to retrieve and process the stored output. In an example, circuits can be configured to initiate or receive communications with input or output devices and can operate on a resource (e.g., a collection of information).

The various operations of method examples described herein can be performed, at least partially, by one or more processors that are temporarily configured (e.g., by software) or permanently configured to perform the relevant operations. Whether temporarily or permanently configured, such processors can constitute processor implemented circuits that operate to perform one or more operations or functions. In an example, the circuits referred to herein can comprise processor-implemented circuits.

Similarly, the methods described herein can be at least partially processor implemented. For example, at least some of the operations of a method can be performed by one or processors or processor-implemented circuits. The performance of certain of the operations can be distributed among the one or more processors, not only residing within a single machine, but deployed across a number of machines. In an example, the processor or processors can be located in a single location (e.g., within a home environment, an office environment or as a server farm), while in other examples the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., Application Program Interfaces (APIs).)

Example embodiments (e.g., apparatus, systems, or methods) can be implemented in digital electronic circuitry, in computer hardware, in firmware, in software, or in any combination thereof. Example embodiments can be implemented using a computer program product (e.g., a computer program, tangibly embodied in an information carrier or in a machine readable medium, for execution by, or to control the operation of, data processing apparatus such as a programmable processor, a computer, or multiple computers).

A computer program can be written in any form of programming language, including compiled or interpreted languages, and it can be deployed in any form, including as a stand-alone program or as a software module, subroutine, or other unit suitable for use in a computing environment. A computer program can be deployed to be executed on one computer or on multiple computers at one site or distributed across multiple sites and interconnected by a communication network.

In an example, operations can be performed by one or more programmable processors executing a computer program to perform functions by operating on input data and generating output. Examples of method operations can also be performed by, and example apparatus can be implemented as, special purpose logic circuitry (e.g., a field programmable gate array (FPGA) or an application-specific integrated circuit (ASIC)).

The computing system can include clients and servers. A client and server are generally remote from each other and generally interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine 800) and software architectures that can be deployed in example embodiments.

In an example, the machine 800 can operate as a standalone device or the machine 800 can be connected (e.g., networked) to other machines. In a networked deployment, the machine 800 can operate in the capacity of either a server or a client machine in server-client network environments. In an example, machine 800 can act as a peer machine in peer-to-peer (or other distributed) network environments. The machine 800 can be a personal computer (PC), a tablet, a server, a cloud resource, a mobile telephone, a web appliance, a network router, switch or bridge, or any machine capable of executing instructions (sequential or otherwise) specifying actions to be taken (e.g., performed) by the machine 800. Further, while only a single machine 800 is illustrated, the term “machine” shall also be taken to include any collection of machines that individually or jointly execute a set (or multiple sets) of instructions to perform any one or more of the methodologies discussed herein.

Example machine (e.g., computer system) 800 can include a processor 802 (e.g., a central processing unit (CPU), a graphics processing unit (GPU) or both), a main memory 804 and a static memory 806, some or all of which can communicate with each other via a bus 809. The machine 800 can further include a display unit 810, an alphanumeric input device 812 (e.g., a keyboard), and a user interface (UI) navigation device (e.g., a mouse). In an example, the display unit, input device, and UI navigation device 814 can be a touch screen display. The machine 800 can additionally include a storage device (e.g., drive unit) 816, a signal generation device 818 (e.g., a speaker), a network interface device 820, and one or more sensors 821, such as a global positioning system (GPS) sensor, compass, accelerometer, or other sensor.

The storage device 816 can include a machine readable medium 822 on which is stored one or more sets of data structures or instructions 824 (e.g., software) embodying or utilized by any one or more of the methodologies or functions described herein. The instructions 824 can also reside, completely or at least partially, within the main memory 804, within static memory 806, or within the processor 802 during execution thereof by the machine 800. In an example, one or any combination of the processor 802, the main memory 804, the static memory 806, or the storage device 816 can constitute machine readable media.

While the machine readable medium 822 is illustrated as a single medium, the term “machine readable medium” can include a single medium or multiple media (e.g., a centralized or distributed database, and/or associated caches and servers) that configured to store the one or more instructions 824. The term “machine readable medium” can also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine readable medium” can accordingly be taken to include, but not be limited to, solid-state memories, and optical and magnetic media. Specific examples of machine readable media can include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 824 can further be transmitted or received over a communications network 826 using a transmission medium via the network interface device 820 utilizing any one of a number of transfer protocols (e.g., frame relay, IP, TCP, UDP, HTTP, etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.11 standards family known as Wi-Fi®, IEEE 802.16 standards family known as WiMax®), peer-to-peer (P2P) networks, among others. The term “transmission medium” shall be taken to include any intangible medium that is capable of storing, encoding or carrying instructions for execution by the machine, and includes digital or analog communications signals or other intangible medium to facilitate communication of such software.

In further examples, computing device 810 can further include a display 816 and/or one or more inputs 820. In some embodiments, the display 816 can include any suitable display devices, such as a computer monitor, a touchscreen, a television, an infotainment screen, etc. to display a user portal, interface, dashboard, reports, smart contract interfaces, etc. In further embodiments, and/or the input(s) 820 can include any suitable input devices (e.g., a keyboard, a mouse, a touchscreen, a microphone, etc.).

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for tracking and reporting a company's emissions information to a value chain platform, comprising:
verifying a supplier's admission to the value chain platform;
arranging execution of a first smart contract with the supplier, corresponding to a purchase of a supplied good or service from the supplier;
receiving and storing data indicative of a first token of the value chain platform, the first token representing aggregated emissions information corresponding to provision of the supplied good or supply service from the supplier to the company;
storing company emission data, the company emission data having been generated by tracking emissions caused by the company in generating a sale good or sale service according to requirements of the value chain platform;
allocating at least a portion of the aggregated emissions information contained in the first token to generation of the sale good or sale service; and
arranging execution of a second smart contract with a customer, corresponding to a sale of the sale good or sale service;
wherein execution of the second smart contract combines the company emission data and the portion of the aggregated emissions information contained in the first token to form a second token of the value chain platform representing emissions from the sale of the sale good or sale service.

2. The method of claim 1, wherein the value chain platform comprises a permissioned blockchain ledger.

3. The method of claim 1, wherein the value chain platform is managed by a managing firm downstream of the company within a value chain corresponding to the value chain platform.

4. The method of claim 1, wherein the first token and the second token are non-fungible tokens (NFTs) of the value chain platform.

5. The method of claim 1, wherein the first token represents data comprising an aggregation of emissions data of at least one prior token from an upstream supplier plus emissions data of the supplier.

6. The method of claim 5, wherein the value chain platform obscures an identity of an originating firm of the prior token from being visible to the company to preserve confidentiality of the supplier's respective supply network.

7. The method of claim 1, wherein allocating at least a portion of the aggregated emissions information contained in the first token comprises dividing the first token into multiple sub-divided tokens and allocating at least one sub-divided token as an input to the second smart contract.

8. The method of claim 7 wherein execution of the second smart contract burns the at least one sub-token.

9. The method of claim 1, wherein the value chain platform is managed by a consortium of firms involved in a value chain corresponding to the value chain platform.

10. A management system for a value chain platform comprising:
a processor;
a network interface;
a manager interface comprising a display and input device for a manager of the value chain platform; and
a memory having stored thereon a set of software instructions which, when executed by the processor, cause the processor to:
verify a plurality of digital certificates confirming compliance of a plurality of value chain suppliers of a product value chain, with emissions tracking criteria of the value chain platform;
deploy at least one smart contract on a permissioned blockchain of the value chain platform, the smart contract configured to process one or more existing emissions tokens of upstream suppliers and emissions data of a current supplier, to automatically mint a new emissions token representing a combination of the one or more existing emissions tokens and the emissions data of the current supplier; and
generate a report of cumulative emissions relating to at least a portion of the product value chain, based on the new emissions token from a first tier supplier of the manager.

11. The system of claim 10 wherein the software instructions further cause the processor to determine an allocation of permissions for each of the plurality of value chain suppliers' access to information within the value chain platform, including permission to access at least one of: upstream transactions within the value chain platform, downstream transactions within the value chain platform, and identity information of upstream and downstream suppliers within the value chain platform.

12. The system of claim 10, wherein the at least one smart contract is configured to automatically mint a new emissions token representing emissions data of at least one upstream emissions token from a supplier of a component of a product; and emissions data of a seller of the product.

13. The system of claim 12, wherein the at least one smart contract automatically mints a new emissions token on the value chain platform, corresponding to the product being sold upon transfer of the product to a purchaser.

14. The system of claim 10 wherein the software instructions further cause the processor to provide a dashboard allowing a user to generate on-demand reports of real-time cumulative emissions by product line, batch, or unit of a product.

15. The system of claim 14 wherein all emissions data of the cumulative emissions is derived from tokens minted by smart contracts deployed on the permissioned blockchain.

16. The system of claim 10 wherein the software instructions further cause the processor to compare emissions information utilized in smart contracts of same-tier suppliers to detect discrepancies indicative of emissions inefficiency or emissions underreporting.

17. The system of claim 10 wherein the at least one smart contract is configured to burn at least one existing emissions tokens of an upstream supplier upon execution.

18. The system of claim 10 wherein the software instructions further cause the processor to assign permissions to each of the plurality of value chain suppliers, including at least one of: which smart contracts a given value chain supplier can utilize.

19. The system of claim 18 wherein the permissions further include whether the given value chain supplier can divide existing emissions tokens of upstream suppliers to allocate only a portion of the emissions data of such a token to execution of a given smart contract.

20. The system of claim 10 wherein the at least one smart contract is configured to process at least one token generated outside of the permissioned blockchain.
